(19) United States
(12) Patent Application Publication
(10) Pub. No.: US 2024/0343258 A1
(43) Pub. Date: Oct. 17, 2024

(54) TECHNIQUES FOR CONSTRAINED OPTIMIZATION OF TORQUE VARIABLES IN MULTI-DIMENSIONAL SPACE FOR ELECTRIFIED POWERTRAINS

(71) Applicant: FCA US LLC, Auburn Hills, MI (US)

(72) Inventors: Szabolcs Sovenyi, Bloomfield Hills, MI (US); Feisel Weslati, Troy, MI (US)

(21) Appl. No.: 18/301,332

(22) Filed: Apr. 17, 2023

(51) Int. Cl. B60W 50/06; B60L 3/00; B60W 50/02

(52) U.S. Cl. CPC B60W 50/06; B60L 3/0061; B60W 50/0205

(57) ABSTRACT

A control and calibration or testing system for an electrified powertrain of an electrified vehicle includes a set of torque actuators of the electrified powertrain, the set of torque actuators comprising at least one electric motor and an internal combustion engine, and an external calibration or testing system for a controller of the electrified vehicle, the external calibration or testing system being configured to embed a six-dimensional (6D) system constraints library (SYCOL) function, wherein the embedded 6D SYCOL function is configured to simultaneously optimize up to six torque variables of the electrified powertrain and, based on a set of vehicle operating parameters, utilize the embedded 6D SYCOL function for online optimization of the up to six torque variables of the electrified powertrain for a corresponding function of the electrified vehicle controller and control of the set of torque actuators accordingly to improve vehicle performance and efficiency.

### FIELD

The present application generally relates to electrified powertrain control and, more particularly, to techniques for constrained optimization of torque variables in multi-dimensional space for electrified powertrains.

### BACKGROUND

Electrified vehicles often include a plurality of torque generating devices, such as one or more electric motors and an internal combustion engine. At any point during vehicle operation, these various prime movers deliver various levels of torque (while operating as torque generators or torque consumers) and therefore need to be synchronized to deliver an optimized combination of torque levels that satisfy certain vehicle performance criteria. Conventional controller-embedded control techniques are unable to simultaneously optimize the control of a plurality of electrified powertrain actuators (e.g., five actuators) with a 100% accuracy as this process is mathematically complex and computationally intensive. These conventional control techniques are therefore suboptimal in that they do not fully optimize vehicle performance and/or deliver the maximum possible efficiency. Accordingly, while such conventional electrified powertrain controller-embedded control techniques and offline reference functions for testing/verifying their accuracy do work for their intended purpose, there exists an opportunity for improvement in the relevant art.

### SUMMARY

According to one example aspect of the invention, a control and calibration or testing system for an electrified powertrain of an electrified vehicle is presented. In one exemplary implementation, the system comprises a set of torque actuators of the electrified powertrain, the set of torque actuators comprising at least one electric motor and an internal combustion engine and an external calibration or testing system for a controller of the electrified vehicle, the external calibration or testing system being configured to embed a six-dimensional (6D) system constraints library (SYCOL) function, wherein the embedded 6D SYCOL function is configured to simultaneously optimize up to six torque variables of the electrified powertrain and, based on a set of vehicle operating parameters, utilize the embedded 6D SYCOL function for online optimization of the up to six torque variables of the electrified powertrain for a corresponding function of the electrified vehicle controller and control of the set of torque actuators accordingly to improve vehicle performance and efficiency.

In some implementations, the controller is configured to output results of its online optimization function to the external calibration or testing system for accuracy verification compared to outputs of the 6D SYCOL function. In some implementations, the external calibration or testing system is further configured to determine a computationally acceptable number of starting points Ns of all possible starting points for iterations of the 6D SYCOL function. In some implementations, the external calibration or testing system is further configured to, for each iteration i of Ni, calculate an intersection point of each constraint surface with a probing straight line therethrough. In some implementations, the external calibration or testing system is further configured to, for each iteration i of Ni, algebraically overlay intervals meeting the constraints along the probing straight line and determine a minimum or maximum value of the objective function within the overlay intervals.

In some implementations, the external calibration or testing system is further configured to, for each iteration i of Ni, modifying the direction and location of the probing straight line to improve the minimum or maximum value of the objective function. In some implementations, the external calibration or testing system is configured to modify the probing straight line by keeping its orientation the same, moving the probing straight line in a direction, and adding fixed values to one or more of the coordinates of the starting point Ps of the straight line. In some implementations, the external calibration or testing system is configured to modify the probing straight line by fixing one of its points and rotating the probing straight line by an angle. In some implementations, the up to six torque independent variables include engine torque and five motor torques.

According to another example aspect of the invention, a control and calibration or testing method for an electrified powertrain of an electrified vehicle is presented. In one exemplary implementation, the method comprise embedding, by a calibration or testing system external of the electrified vehicle, a 6D SYCOL function, wherein the embedded 6D SYCOL function is configured to simultaneously optimize up to six torque variables of the electrified powertrain and, based on a set of vehicle operating parameters, utilizing, by the external calibration or testing system and for a controller of the electrified vehicle, the embedded 6D reference function for online optimization of the up to six torque variables of the electrified powertrain for a corresponding function of the electrified vehicle controller and control of a set of torque actuators of the electrified powertrain accordingly to improve vehicle performance and efficiency, wherein the set of torque actuators comprises at least one electric motor and an internal combustion engine.

In some implementations, the method further comprises outputting, by the controller, output results of its online optimization function to the external calibration or testing system for accuracy verification compared to outputs of the 6D SYCOL function. In some implementations, the external calibration or testing system is further configured to determine a computationally acceptable number of starting points Ns of all possible starting points for iterations of the 6D reference function. In some implementations, the external calibration or testing system is further configured, for each iteration i of Ni, to calculate an intersection point of each constraint surface with a probing straight line therethrough. In some implementations, the external calibration or testing system is further configured to, for each iteration i of Ni, algebraically overlay intervals meeting the constraints along the probing straight line and determine a minimum or maximum value of the objective function within the overlay intervals.

In some implementations, the external calibration or testing system is further configured to, for each iteration i of Ni, modifying the probing straight line to improve the minimum or maximum value of the objective function. In some implementations, the external calibration or testing system is configured to modify the probing straight line by keeping its orientation the same, moving the probing straight line in a direction, and adding fixed values to one or more of the coordinates of the starting point Ps of the probing straight line. In some implementations, the external calibration or testing system is configured to modify the probing straight line by fixing one of its points and rotating the probing straight line by an angle. In some implementations, the up to six torque independent variables include engine torque and up to five motor torques.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature, intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1A is a functional block diagram of an example control and calibration or testing system for an electrified powertrain of an electrified vehicle according to the principles of the present application;

FIG. 1B is a flow diagram illustrating the principle of testing the vehicle-embedded control software according to the principles of the present application, where the output of the embedded control software is compared to that of the reference function, and the two systems are being sent the same input;

FIGS. 2A-2C are diagrams illustrating the Naville-Sovenyi Theorem, a vector rotation function and a probing straight line for calculating intersections with constraint surfaces according to the principles of the present application; and

FIG. 3 is a flow diagram of an example constrained optimization method of torque variables in multi-dimensional space for an electrified powertrain according to the principles of the present application.

### DESCRIPTION

Until the arrival or hybrid and fully electrified vehicles, vehicle powertrains only used to have one prime mover—an internal combustion engine. The problem of optimizing torque levels and other variables across multiple prime movers is therefore relatively new. Also, there are many simpler algorithms for managing such powertrains, albeit potentially at lower energy efficiency, lower ride comfort, suboptimal maneuverability, etc. For instance, if an assumption is made about the ratios of the various motor and engine torque levels to each other, then the optimization task of finding the minimum and maximum total powertrain torque becomes greatly simplified. Alternatively, detailed calibration tables that classify all driving scenarios into a few, broad categories and assign controller gains, torque limits, and the like accordingly, will be able to control the powertrain with some level of fidelity. These controller gains and torque limits can be determined experimentally for each driving scenario category. To most customers driving at modest torque demand levels, especially if they don't strictly monitor energy efficiency, a calibration table-based controller will likely be indistinguishable from a sophisticated, optimization algorithm-based controller.

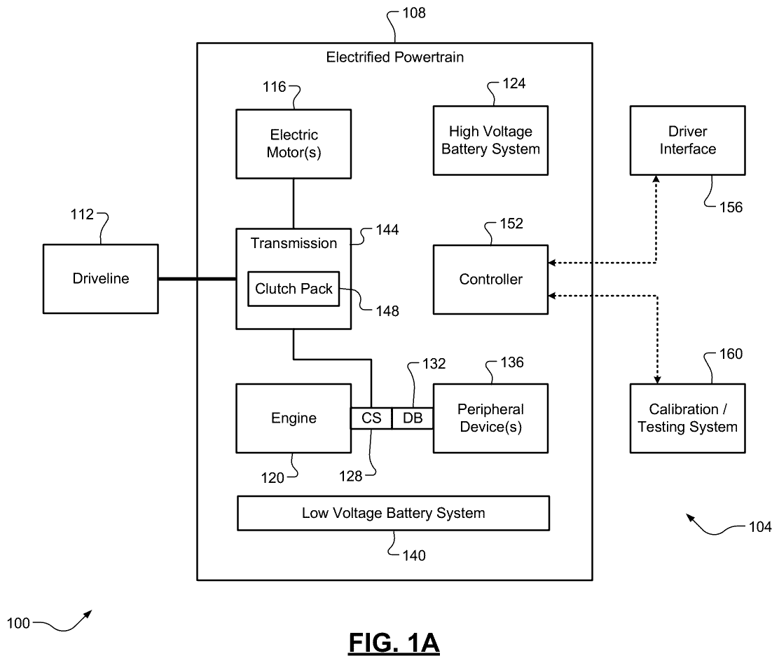

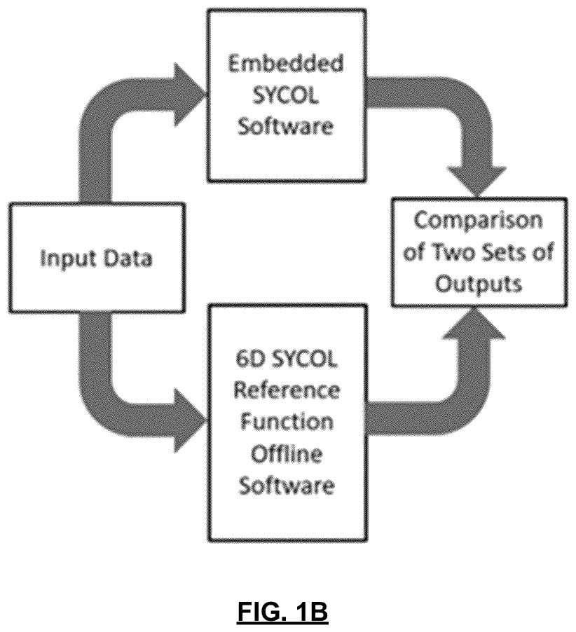

As previously discussed, today's electrified vehicles often include a plurality of torque generating devices, such as one or more electric motors and an internal combustion engine. At any point during vehicle operation, these various prime movers deliver various levels of torque (in addition to operability as torque generators or torque consumers) and therefore need to be synchronized to deliver an optimized combination of torque levels that satisfies certain vehicle performance criteria. One of the building blocks of the electrified powertrain's embedded control software computes the maximum and minimum values of objective functions, such as output torque, as a function of engine torque, hybrid motor torque and other variables. To test such embedded software, an offline reference function was created. This reference function calculates the ideal minimum and maximum values to be compared with the output of the embedded software, as shown in FIG. 1B. The present application presents a specific offline constrained optimization reference function with an emphasis on mathematical novelties. This is the primary topic of the present application. The reference function computes the minimum and maximum points of a linear objective function as a function of six independent variables, subject to 42 linear and two (2) nonlinear constraints (or a total of 44 constraints).

On the one hand, conventional control techniques are able to simultaneously optimize the control of a plurality of electrified powertrain actuators (e.g., five actuators) with a 100% accuracy are mathematically complex and computationally intensive and cannot run in an embedded processor. On the other hand, the control techniques that are sufficiently simple and quick to execute in a control module embedded in the vehicle are not perfectly accurate. The embedded control techniques used in vehicles are therefore suboptimal in that they do not fully optimize vehicle performance. Specifically, we are unaware of the existence of embedded powertrain control software that addresses the accurate optimization in six-dimensional (6D) space, while satisfying a very large number of (e.g., 44) constraints in a prioritized fashion. The embedded control software that does exist is not completely accurate and it needs testing and refinement. The testing needs an offline reference function that computes the ideal optimum points accurately 100% of the time. The reference function takes 40-50 minutes to process a single test case. As a result, such reference function can only run offline, outside of the embedded controller environment. Perhaps, if in ten years quantum computers become widespread in vehicles. In that case, in principle, these techniques could operate online in a vehicle. For now, they are more likely intended to be used offline during vehicle software testing.

Accordingly, improved techniques for constrained optimization of torque variables in 6D space for electrified powertrains are presented herein. The methods work both with linear and nonlinear constraints. The methods work both with convex and concave domains. The methods work both with single-domain and multi-domain scenarios. The algorithm successfully handles challenging features such as concave domains, curved surfaces, disjointed domains, and multiple local extremum points. The techniques must calculate minimum and maximum values of some angular acceleration or torque variable that will bound the achievable vehicle performance, which is the objective function. Also, the minimum or maximum of the objective function must be found while satisfying some set of constraints. For example, the following five variables could be kept within preset minimum and maximum limits: (1) drive belt torque, (2) clutch pack torque, (3) electric motor torque, (4) engine torque, and (5) battery power. The constraint inequalities are defined in a proprietary, generalized torque variable domain and the handling of non-overlapping constraints is also defined specifically based on needs of the electrified powertrains.

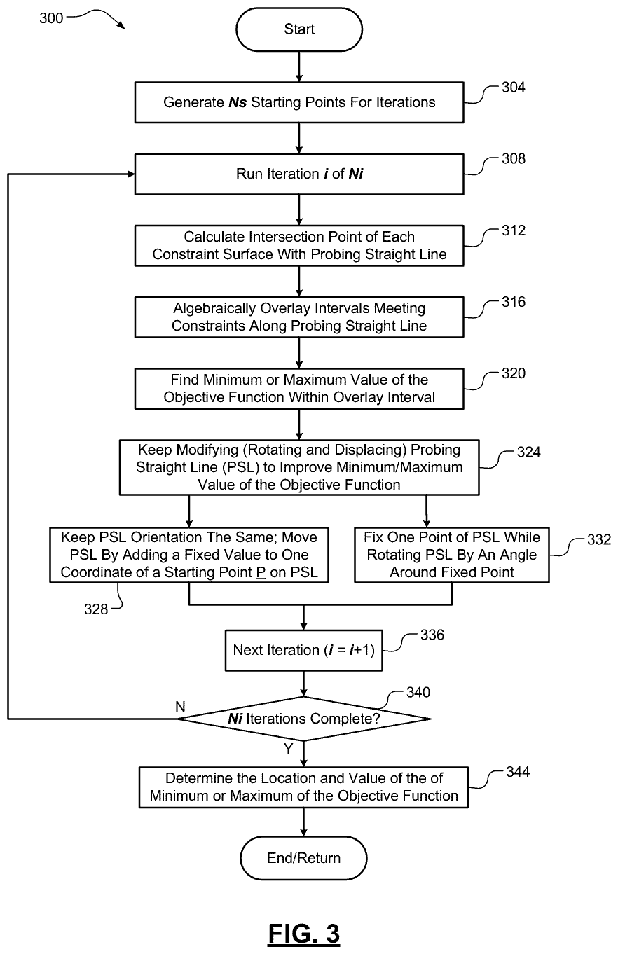

The reference function algorithm has several building blocks. As a theorem, the conditions and methods for running trigonometric calculations in 6D Euclidean space are presented. More complex geometric structures can be built by joining multiple triangles, adding one triangle at a time. Extensions to other dimensional spaces (4D, 5D, 7D, etc.) are shown to be straightforward. As a tool for finding the optimum point, a probing straight line (PSL) is constructed. FIG. 3 illustrates the operation of the algorithm. Based on the rules of 6D trigonometry, the intersection points of the PSL and the constraint surfaces are calculated. The overlap zone of the constraints is determined along the 6D probing straight line. The optimum point is found within the overlap zone. The algorithm iteratively changes the location and orientation of the straight line to find the optimum point. A unique formula for rotating any straight line by a given angle in 6D space is derived. The iteration with the probing straight line runs with a large total number (e.g., Ns=2.1 million) of possible starting points. In any iteration algorithm, the number of starting points must be determined (e.g., Ns˜1000). This is usually done based on intuition and experience. In the present application, the minimum number of required iteration starting points is determined as a function of the required probability of finding the global optimum.

The following are five unique and innovative features of the present application apart from other optimization algorithms that already exist. First, the implementation of a probing straight line to algebraically overlap constraints in N-dimensional space (3≤N). Second, a formula for the rotation of the probing straight line in N-dimensional space (3≤N) by a given angle, where one of the elements of the direction vector of the straight line is incremented as a function of the desired angle of rotation. Third, the repeated displacement and rotation of a probing straight line in an iterative fashion to find the optimum point, while satisfying the largest possible number of constraints. Fourth, a probability-based formula for the determination of the necessary starting points, Ns needed for an iteration. Fifth and finally, the implementation of known equations of 2D trigonometry in N-dimensional spaces, where 3≤N.

Referring now to FIG. 1A, a functional block diagram of an example control and calibration or testing system 104 for an electrified powertrain 108 of an electrified vehicle 100 is illustrated. The electrified vehicle 100 could have any suitable configuration (hybrid electric vehicle (HEV), plug-in HEV (PHEV), range-extended electrified vehicle (REEV), battery electric vehicle (BEV), etc.) having two or more torque actuators (or prime movers) in its electrified powertrain 108. The electrified powertrain 108 is generally configured to generate and transfer drive torque to a driveline 112 for vehicle propulsion. The electrified powertrain 108 includes one or more electric motors 116 and an internal combustion engine 120. The electric motor(s) 116 are configured to rotate generating drive torque based on alternating current provided by an inverter (not shown) and a high voltage battery system 124. Each electric motor 116 can operate in a motoring mode (torque generator) or a generator mode (torque consumer). The engine 120 is configured to combust a mixture of air and fuel (gasoline, diesel, etc.) to rotate a crankshaft 128 generating drive torque. A drive belt (or serpentine belt) 132 is connected to the crankshaft 128 and configured to drive one or more peripheral devices 136, such as an alternator. A low voltage battery system 140 is also configured to provide low voltage power (e.g., 12 Volt power) to power or receive energy from at least some of the peripheral devices 136. An automatic transmission 144 comprising a clutch pack 148 is configured to transfer the drive torque from the electric motor(s) 116 and the engine 120 to the driveline 112. It will be appreciated that the illustrated powertrain 108 and driveline 112 are merely example configurations, and the teachings of the present application are applicable to any suitable electrified vehicle having a powertrain/driveline configuration with six or fewer of electric motors and engines.

A controller 152 is configured to control operation of the electrified vehicle 100 and, more specifically, the electrified powertrain 108, such that it satisfies a torque request provided by an operator or driver of the electrified vehicle 100 via a driver interface 156 (e.g., an accelerator pedal). An external calibration or testing system 160 is also configured to update software of the controller 152 and to verify the accuracy of the controller 152 as described in greater detail below. The embedded control software aims to find the best operating point of electrical and mechanical power and torque levels to attain a variety of sometimes contradictory objectives in a balanced fashion, such as fuel efficiency, high acceleration and deceleration, maneuverability, and so on. To this end, an optimization process is implemented as an algorithm that maximizes an objective function, (output torque for example), with respect to at most six independent variables the software can control, typically electric motor torque and engine torque. For purposes of the offline reference function, which is a core inventive aspect of the present application, the number of independent variables is set to six (6D) because this is the highest imaginable combined number of engines and electric motors an electrified vehicle could have in the foreseeable future. Each independent variable is a torque value produced by an electromotor or the engine. When a particular electrified powertrain has fewer than six torque actuators, one or more of the dimensions of the 6D system will be turned off. If much faster processors become available in vehicle controllers, then the 6D SYCOL algorithm shown in FIG. 3 and described in greater detail below could run embedded in the controller 152. In that case, it would not run in the external calibration or testing system 160. In other words, in this scenario, there is no testing of embedded SYCOL functionality. The 6D SYCOL runs in the controller 152 to optimize powertrain performance.

The 44 constraint inequalities describe the physical limitations of the powertrain and driveline. The constraint inequalities may for instance describe the capacity limits of: (1) drive belt torque, (2) clutch pack torque, (3-4) electric motor torque (e.g., two electric motors), (5) engine torque, and (6) battery power. The optimization process must find the two points where an objective function reaches its minimum and maximum values while honoring these system constraints. For instance, the torque levels must stay below the limits allowed for clutches and drive belts, the high voltage battery charging and discharging power must stay in the safe operating zones, and so on. These constraints are expressed as linear and quadratic inequalities of the independent variables. This constrained optimization problem is solved by an embedded software routine also referred to as a Systems Constraints Library (or “SYCOL”). SYCOL is a software routine that is called by other control software systems many times a second. SYCOL is a static system; that is, it has no memory and no dynamic response. For example, a block diagram implementation or representation of SYCOL could have over 366,000 blocks. Depending on which side of which constraint surface the operating point or test point falls, the software keeps switching between different calculation algorithms and keeps searching for different constraint surface intersection points. Also, there can be specific rules for handling mutually contradictory constraints.

The constraints are ranked based on priority. Constraints with higher priority must be satisfied first. If a constraint cannot be satisfied, then the optimum point must be placed within the last constraint boundary that is still satisfied, and at a minimum distance from the first constraint surface that is not satisfied. In these situations, the objective function is ignored, so the optimum point could potentially be placed on a surface where the objective function gives the least favorable value. All of this leads to a switched, sometimes stepwise, nonlinear behavior in the SYCOL outputs as a function of the inputs. Due to the limited execution time available in the embedded processor, SYCOL is designed based on a speed-accuracy trade-off. Years of driving experience in test vehicles and production vehicles proves that SYCOL provides good results in most driving situations. To make sure SYCOL provides the best attainable result in every driving situation, the embedded SYCOL library must be validated. The overall process flow of the validation test is illustrated in FIG. 1B. When the 6D SYCOL reference function illustrated in FIG. 3 and described in greater detail below is used for testing as shown in FIG. 1B, then all components in FIG. 1B reside in an offline computer or computing system (e.g., a laptop or workstation). That is, nothing runs in the vehicle controller 152. During testing with the 6D SYCOL reference function shown in FIG. 3, everything runs in simulation and nothing is connected to the vehicle 100.

To validate the embedded SYCOL software, an input dataset (representative of the driving situations and vehicle powertrain architectures that the embedded software must handle) was created. The input data set, composed of hundreds of use cases, is sent through the embedded SYCOL and the results were recorded. To calculate the ideal output for each input dataset, the 6D SYCOL reference function was run. The 6D SYCOL reference function runs offline on a workstation and can take up to an hour to calculate the output for each use case if necessary. The 6D SYCOL reference function is given the time and processing power to calculate the ideal outputs as best as it can. The 6D SYCOL reference function does not take shortcuts or compromise accuracy in any other way. The input data is also sent through the embedded SYCOL software and the outputs of the two systems are compared. If the two do not match, then both systems are scrutinized for the cause of the inaccuracy. The present application focuses on the 6D SYCOL reference function and the mathematical novelty behind it. This reference function must find the minimum and maximum locations and values of a linear objective function of six independent variables. These optimum points must satisfy 42 linear (hyper-planar) and two quadratic (hyper-cylindrical) constraints in the [symbol] ⁶ space, as a function of six variables: Tᵢ, Tᵥ, T_{w}, Tₓ, T_{y}, T_{z}. Tᵢ is engine torque, while the other five variables indicate electric motor torque. To match the nature of the SYCOL embedded software, the reference function must also be a static system with no memory.

An objective function Tm₁ is given as a linear function of six independent variables: Tᵢ, Tᵥ, T_{w}, Tₓ, T_{y}, T_{z}. On this variable list, Tᵢ is a legacy notation for engine torque, with the index “i” referring to the input side of an automatic transmission. Tᵥ, T_{w}, Tₓ, T_{y}, and T_{z} are generalized electromotor torque variables actuated at various parts of the powertrain:

$$T {m}_{1} = {T}_{i} \cdot Ti 2 {Tm}_{1} + {T}_{v} \cdot Tv 2 {Tm}_{1} + {T}_{w} \cdot Tw 2 {Tm}_{1} + {T}_{x} \cdot Tx 2 {Tm}_{1} + {T}_{y} \cdot Ty 2 {Tm}_{1} + {T}_{z} \cdot Tz 2 {Tm}_{1} + {CTm}_{1}$$

The constant coefficient Tv2Tm₁ indicates the contribution of the independent variable Tᵥ “to” the objective function Tm₁. The names of the other coefficients can be interpreted in an analogous fashion. The coefficients are determined based on powertrain architecture, transmission gear, vehicle operation mode, etc. a priori to the optimization process and they fall outside of the scope of this document. CTm₁ is a constant term in the linear equation and it incorporates a variety of friction and viscous loss terms and other terms that do not include any of the six independent torque variables. Because the objective function is linear, the optimum point will be somewhere on the surface of the constrained domain. Also given are 44 constraint inequalities as a function of the same six variables. The 44 inequalities include: 42 linear constraints in 6D space and two (2) quadratic constraints in 6D space. The constraint surfaces represent the saturation limits and load capacity limits of various powertrain components.

The maximum constraint inequality for the k-th linear constraint variable Tmₖ is written out as:

$$T {m}_{k max} \leq {T}_{i} \cdot Ti 2 {Tm}_{k} + {T}_{v} \cdot Tv 2 {Tm}_{k} + {T}_{w} \cdot Tw 2 {Tm}_{k} + {T}_{x} \cdot Tx 2 {Tm}_{k} + {T}_{y} \cdot Ty 2 {Tm}_{k} + {T}_{z} \cdot Tz 2 {Tm}_{k} + {CTm}_{k}$$

This equation exemplifies the structure of the equation of a 6D hyperplane. In practice, the constraint variable Tmₖ may be for instance a belt drive torque capacity limit, or some other limit that the actuator torque request levels must honor. The generalized torque variables Tᵥ, T_{w}, Tₓ, T_{y}, T_{z} also must satisfy the Rₘᵢₙ and Rₘₐₓ quadratic, hyper-cylindrical constraints as shown in the inequalities below. These are the 43^{rd} and 44^{th} constraint surfaces.

$${R}_{min} \leq {T}_{v}^{2} + {T}_{w}^{2} + {T}_{x}^{2} + {T}_{y}^{2} + {T}_{z}^{2}$$

$${T}_{v}^{2} + {T}_{w}^{2} + {T}_{x}^{2} + {T}_{y}^{2} + {T}_{z}^{2} \leq {R}_{max}$$

The Tᵢ coordinate does not show up in these two inequalities. As a matter of general principle, already applicable in 2D and 3D, it can be stated that if the j-th coordinate Xⱼ is missing from an equation or inequality given in N-dimensional space, then that equation or inequality is stated to hold true for all values of the missing coordinate, Xⱼ.

The equation or inequality determines a certain shape, S in the Xⱼ=0 subspace, which is N−1 dimensional. To visualize the shape of the object in N-dimensional space, shape S, as a cross section, is to be extruded along the Xⱼ axis, to obtain an N-dimensional object. So in 6D space, the inequality involving Rₘₐₓ, with Tᵢ missing, determines a hypercylinder that has the Tᵢ as the axis of rotation and a radius of Rₘₐₓ. Rₘᵢₙ<Rₘₐₓ in all of our applications. Therefore, the inequality involving Rₘᵢₙ determines a concentric, hyper-cylindrical hole inside the Rₘₐₓ hyper-cylinder, concentric and coaxial with the Rₘₐₓ hyper-cylinder. In 3D space, under some corner cases, eight or more disjoint domains may be created. In dimensions higher than three, even more domains may exist simultaneously. Each must be considered as a potential candidate for having the optimum point on its surface. The Rₘₐₓ and Rₘᵢₙ cylindrical constraints exist in the 3D version of SYCOL also. The

$${R}_{min} \leq {T}_{x}^{2} + {T}_{y}^{2}$$

cylindrical constraint removes the central, cylindrical part of the domain. Due to the Rₘᵢₙ cylindrical constraint, disjoint domains and concave domains are possible. The concave domains may take a variety of shapes, for instance, there can be two larger volumes connected by a narrow, curvy pathway; or there can be various hollowed-out shapes; or crescent shapes. On these concave surfaces, there can be multiple local minimum and local maximum points.

The 6D SYCOL reference function must find the minimum and maximum of the linear objective function, while, to the extent possible, satisfying the 44 constraints in 6D space. Some pairs among the 44 constraint surfaces may contradict each other. In that case the contradictions must be resolved based on priorities specified by an engineering team. Constraints with higher priorities must be satisfied to the extent possible, only after that can the algorithm consider finding ways to satisfy other constraints of lower priority. The planar constraints must be satisfied with higher priority than the cylindrical ones. If constraint P is prioritized one level higher than constraint Q, and they are contradictory, and all constraints k (k=1, . . . P) are possible to satisfy by an overlapped domain then the solution point must be searched on the surface of constraint P, and the optimum point must be chosen from among those points that fall within the shortest possible distance to the surface of constraint Q (P=Q−1). Collapsed constraints, also known as “pinched constraints,” are sometimes encountered during optimization. A collapsed constraint is defined as a pair or inequalities that have the same minimum and maximum values assigned to them, for instance:

$${Tm}_{5 min} = 0 \leq {T}_{i} \cdot Ti 2 {Tm}_{5} + {T}_{v} \cdot Tv 2 {Tm}_{5} + {T}_{w} \cdot Tw 2 {Tm}_{5} + + {T}_{x} \cdot Tx 2 {Tm}_{5} + {T}_{y} \cdot Ty 2 {Tm}_{5} + {T}_{z} \cdot Tz 2 {Tm}_{5} + {CTm}_{5}$$

$${Tm}_{5 max} = 0 \geq {T}_{i} \cdot Ti 2 {Tm}_{5} + {T}_{v} \cdot Tv 2 {Tm}_{5} + {T}_{w} \cdot Tw 2 {Tm}_{5} + + {T}_{x} \cdot Tx 2 {Tm}_{5} + {T}_{y} \cdot Ty 2 {Tm}_{5} + {T}_{z} \cdot Tz 2 {Tm}_{5} + {CTm}_{5}$$

Of course, this means that the right side of the two constraint inequalities must be equal to zero. The operating point must be constrained to stay on the single surface representing both the minimum and the maximum values. The 6D SYCOL reference function must handle all of these challenges.

The 6D SYCOL reference function is a complex mathematical algorithm that uses several foundational building blocks. While the mathematical formulas were developed for a six-dimensional application, they are equally applicable in any N-dimensional space, where N is an integer greater than two. To serve as building blocks for the invention disclosed herein, some new elements of 6D Euclidean analytical geometry will be discussed. There is a variety of ways to define distances, angles and other quantities in 6D space. In this disclosure a 6D Euclidean space is assumed with some calculation methods and definitions carried over from 2D and 3D Euclidean spaces. As long as the following three definitions for distance, vector norm and angle are used:

The distance D between two points P₁ and P₂ is defined based on a six-dimensional equivalent of the Pythagorean theorem:

$$D = \sqrt[2]{{\sum }_{j = 1}^{N} {( {P}_{1 j} - {P}_{2 j} )}^{2}}$$

where and P₁ⱼ is the “j”-th coordinate of the first point, j=1, . . . , N. P₂ⱼ is the “j”-th coordinate of the second point, j=1, . . . , N. In the six-dimensional case, N=6.

The length of a free vector X is defined as the two-norm, that is, as the square root of the sum of its squared coordinates:

$$‖ \underline{X} ‖ = \sqrt[2]{{\sum }_{j = 1}^{N} {x}_{j}^{2}}$$

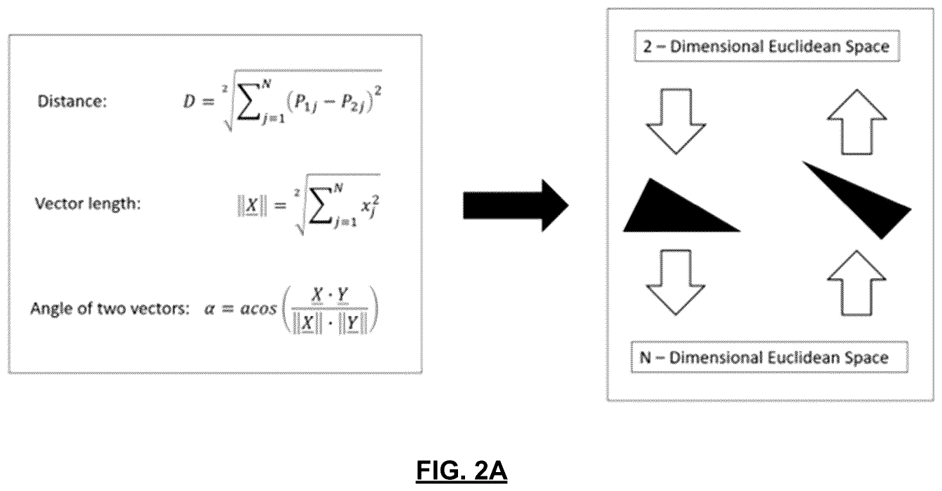

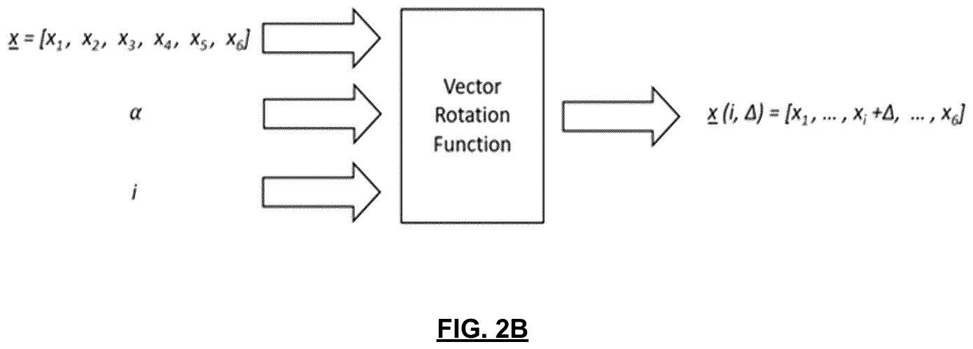

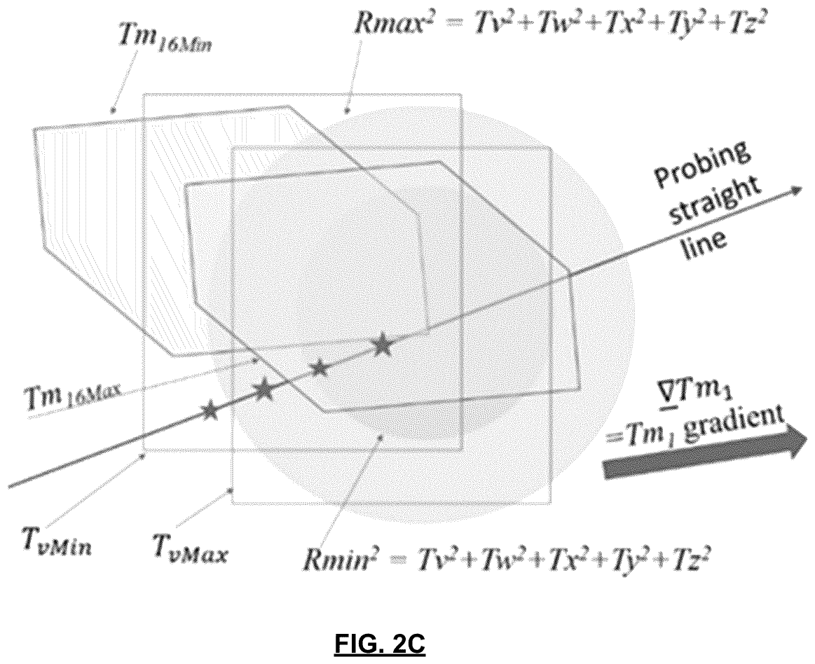

The angle α between N-dimensional vectors X and Y is defined and calculated as:

$$α = acos ( \frac{\underline{X} \cdot \underline{Y}}{‖ \underline{X} ‖ \cdot ‖ \underline{Y} ‖} )$$

where X·Y denotes the scalar product a.k.a. dot product of vectors X and Y, then all rules and formulas of trigonometry, known from 2D Euclidean space, are applicable to N-dimensional triangles, where N is an integer greater than two. This is illustrated in FIG. 2A and is also known as the Naville-Sovenyi theorem. This theorem is used extensively in the calculations of the 6D SYCOL reference function. Based on this theorem, as long as the three conditions are met, it is possible to move a triangle between 2D, 3D, 4D, 6D, etc. Euclidean spaces. More complex structures can be assembled from multiple triangles. The 6D SYCOL reference function disclosed herein uses this principle to find the intersection points of a 6D probing straight line with 6D planar and hyper-cylindrical surfaces.

The 6D SYCOL reference function keeps changing the direction and starting point of a 6D probing straight line. Changing the starting point is straightforward, a number has to be added to at least one of the six coordinates of the point in 6D space. Rotating the direction vector by a certain angle in 6D space requires a formula. Suppose vector x is given in 6D Euclidean space as:

x=[x₁,x₂,x₃,x₄,x₅,x₆]

Suppose the vector x must be rotated by a known angle, α by adding a real scalar number, Δ to the i-th element of the vector. This will, in most cases, modify the length also, and that is acceptable. The following notation is introduced:

$$\underline{x} ( i , Δ ) = [ {x}_{1} , … , {x}_{i} + Δ , … , {x}_{6} ]$$

This means that the i-th element of vector x is incremented by Δ. The task is to find a scalar Δ as a function of i, α, and x such that:

$$acos ( \frac{\underline{x} ( i , Δ ) \cdot \underline{x}}{‖ \underline{x} ( i , Δ ) ‖ \cdot ‖ \underline{x} ‖} ) = α$$

where the norm or length of vector x is calculated as the square root of the sum of its squared coordinates:

$$‖ \underline{x} ‖ = \sqrt[2]{{\sum }_{j = 1}^{6} {x}_{j}^{2}}$$

The input and output data of the vector rotation function is shown in FIG. 2B. This software routine is used to change the orientation of the probing straight line as a part of the iteration of the 6D SYCOL reference function.

Many numerical, iterative minimum and maximum search algorithms exist, and they work based on a variety of different principles. Most of these methods run the iterations with a certain number of starting points. The number of starting points is usually determined based on experimentation, intuition, trial-and-error, and so on. In this disclosure a probabilistic closed formula is presented for determining the number of necessary starting points. The description focuses on finding the global maximum point of the objective function. The procedure is the same for the global minimum.

$$Ns = \frac{ln {α}_{s}}{ln ( 1 - G M H R )}$$

where GHMR (the “global maximum hit ratio”) is defined as follows. Suppose we start a very large number of iterations from a matching number of different, randomized starting points. If the number of starting points is large enough, then some of these will drift to the global maximum point of the objective function.

The GMHR is therefore the following:

$$G H M R = \frac{\begin{matrix}\# of starting points that led to an iteration \\ that converged to the global max value\end{matrix}}{total \# of starting points}$$

0<GMHR<1 is required for the equation to work. Because GMHR is a probability, this criteria is straightforward to fulfill. αₛ is the significance level required for the calculation. A significance level of αₛ=5% is a generally accepted standard in statistics and engineering for non-safety-critical systems, however, the invention includes all possible values of αₛ. αₛ=0.05 means that there is a 1−αₛ=95% likelihood that the results are correct. Some applications may require 99% or even 99.99% likelihood for this value. To use the logarithm in the formula, 0<αₛ is required. Due to the way as is introduced, 0<αₛ is always true. Ns=sample size, that is, the number of starting points for the iteration. This is what needs to be determined. αₛ≤0.05 is expected in practice. GMHR<0.01 is expected for accuracy. As long as these two limits are kept, the formula will always give 1<Ns, which is also in line with the expectation that a sample size should be larger than one. No matter what practical values are defined for GMHR and the significance level αₛ, a finite sample size Ns can always be calculated.

The operating principle of the 6D SYCOL reference function can be summarized as follows. A probing straight line is defined in 6D space based on a line starting point and a direction vector. Then the intersection points of each constraint surface with the probing straight line is calculated, indicated with stars in FIG. 2C. The intersection points of the probing straight line and the Rₘᵢₙ and Rₘₐₓ hypercylinders are also calculated. The calculation of these intersection points relies on 6D triangles and the derivation about 6D trigonometry summarized in the Naville-Sovenyi theorem. Suppose the intersections of the probing straight line with the T_{vMin}, T_{vMax} and Tm_{16Min}, Tm_{16Max} constraint surfaces are marked with the pairs of larger and smaller gray stars, respectively. For visual clarity, the intersections of only two constraint plane pairs are marked on the probing straight line. The straight-line segment between the first pair of stars and the straight line segment between the second pair of stars are zones where the Tᵥ and Tm₁₆ constraints allow the solution points to be located on the line. In the powertrain application considered, the .minimum values are always less than or equal to the maximum values for each constraint and so no constraint plane pair is ever self-contradictory. The overlap zone of the constraints is formed on the straight line, and the Tm_{1Min} and Tm_{1Max} points are located within the overlap zone.

Referring now to FIG. 3 and with continued reference to FIGS. 1A-1B and 2A-2C, an example constrained optimization method (item 300) of torque variables in six-dimensional (6D) space for an electrified powertrain of an electrified vehicle is presented. While the electrified vehicle 100 and its components are specifically referenced for illustrative and descriptive purposes, it will be appreciated that this method 300 could be applicable to any suitable electrified vehicle having multiple prime movers as previously discussed herein. As shown in FIG. 3 and more fully described below, the algorithm keeps changing the orientation (step 332) and location (step 328) of the probing straight line (PSL) iteratively to get close to the optimum point (step 324). Changing one of the coordinates of a line starting point to move that point and the line going through it per step 328 is straightforward. Changing one of the coordinates of a direction vector of a PSL in a way that the straight line will turn by a given angle α per step 332 requires the formula as shown and described herein. During the iterative optimum search process, the six coordinates of the direction vector of the straight line and the six coordinates of the line starting point each are each incremented and decremented over and over.

Increments and decrements that improve the objective function value are kept, the others are discarded (steps 308-336). The sizes of the increments and decrements are cut smaller and smaller as the iteration progresses. To ascertain that the iteration will end within a finite number of steps, each step size is used only a limited number of times. Naturally, since the algorithm is numerical, it is unlikely to ever give an exact result. The algorithm starts this iteration at step 304 with the PSL going through a large number of starting points Ns and with different starting orientations determined by their direction vectors. The results of these Ns iteration runs are saved in a matrix. When all the iterations are complete, the best result is chosen as the final result.

The equation of a 6D straight line states the location of a generic point P as a function of a line starting point Pₛ, a direction vector V and a running parameter g:

$$\underline{P} = \underline{{P}_{s}} + g \cdot \underline{V} , \qquad g ∈ ℜ , \qquad g = - ∞… + ∞$$

In most cases in this disclosure, the search for the maximum point of the objective function was discussed herein (step 320). Finding the minimum works the same way after the signs of the coefficients of the objective function are changed. Based on the diagnostic output flags given by the 6D SYCOL reference function, the retrieved solution points satisfy all the constraints whenever the constraints overlap. In case of iterating to find an optimum point on a curved edge, the results were three decimal digits accurate. In case of iterating to find an optimum point at the intersection of multiple constraint planes, the solution point was nine-to-twelve decimal digits accurate. These were repeating patterns across the test cases.

It will be appreciated that the terms “controller” and “calibration or testing system” as used herein refers to any suitable computing device or set of multiple computing devices that is/are configured to perform at least a portion of the techniques of the present application. While the SYCOL optimization reference function was originally written for offline testing, outside of the vehicle controller environment, it is possible that at some point in the future it may make its way into a very fast controller embedded in a vehicle. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A control and calibration or testing system for an electrified powertrain of an electrified vehicle, the system comprising:
a set of torque actuators of the electrified powertrain, the set of torque actuators comprising at least one electric motor and an internal combustion engine; and
an external calibration or testing system for a controller of the electrified vehicle, the external calibration or testing system being configured to:
embed a six-dimensional (6D) system constraints library (SYCOL) function, wherein the embedded 6D SYCOL function is configured to simultaneously optimize up to six torque variables of the electrified powertrain; and
based on a set of vehicle operating parameters, utilize the embedded 6D SYCOL function for online optimization of the up to six torque variables of the electrified powertrain for a corresponding function of the electrified vehicle controller and control of the set of torque actuators accordingly to improve vehicle performance and efficiency.

2. The system of claim 1, wherein the controller is configured to output results of its online optimization function to the external calibration or testing system for accuracy verification compared to outputs of the 6D SYCOL function.

3. The system of claim 2, wherein the external calibration or testing system is further configured to determine a computationally acceptable number of starting points Ns of all possible starting points for iterations of the 6D SYCOL function.

4. The system of claim 3, wherein the external calibration or testing system is further configured to, for each iteration i of Ni, calculate an intersection point of each constraint surface with a probing straight line therethrough.

5. The system of claim 4, wherein the external calibration or testing system is further configured to, for each iteration i of Ni, algebraically overlay intervals meeting the constraints along the probing straight line and determine a minimum or maximum value of the objective function within the overlay intervals.

6. The system of claim 5, wherein the external calibration or testing system is further configured to, for each iteration i of Ni, modifying the direction and location of the probing straight line to improve the minimum or maximum value of the objective function.

7. The system of claim 6, wherein the external calibration or testing system is configured to modify the probing straight line by keeping its orientation the same, moving the probing straight line in a direction, and adding fixed values to one or more of the coordinates of the starting point Ps of the straight line.

8. The system of claim 6, wherein the external calibration or testing system is configured to modify the probing straight line by fixing one of its points and rotating the probing straight line by an angle.

9. The system of claim 1, wherein the up to six torque independent variables include engine torque and up to five motor torques.

10. A control and calibration or testing method for an electrified powertrain of an electrified vehicle, the method comprising:
embedding, by a calibration or testing system external of the electrified vehicle, a six-dimensional (6D) system constraints library (SYCOL) function, wherein the embedded 6D SYCOL function is configured to simultaneously optimize up to six torque variables of the electrified powertrain; and
based on a set of vehicle operating parameters, utilizing, by the external calibration or testing system and for a controller of the electrified vehicle, the embedded 6D reference function for online optimization of the up to six torque variables of the electrified powertrain for a corresponding function of the electrified vehicle controller and control of a set of torque actuators of the electrified powertrain accordingly to improve vehicle performance and efficiency, wherein the set of torque actuators comprises at least one electric motor and an internal combustion engine.

11. The method of claim 10, further comprising outputting, by the controller, output results of its online optimization function to the external calibration or testing system for accuracy verification compared to outputs of the 6D SYCOL function.

12. The method of claim 11, wherein the external calibration or testing system is further configured to determine a computationally acceptable number of starting points Ns of all possible starting points for iterations of the 6D reference function.

13. The method of claim 12, wherein the external calibration or testing system is further configured, for each iteration i of Ni, to calculate an intersection point of each constraint surface with a probing straight line therethrough.

14. The method of claim 13, wherein the external calibration or testing system is further configured to, for each iteration i of Ni, algebraically overlay intervals meeting the constraints along the probing straight line and determine a minimum or maximum value of the objective function within the overlay intervals.

15. The method of claim 14, wherein the external calibration or testing system is further configured to, for each iteration i of Ni, modifying the probing straight line to improve the minimum or maximum value of the objective function.

16. The method of claim 15, wherein the external calibration or testing system is configured to modify the probing straight line by keeping its orientation the same, moving the probing straight line in a direction, and adding fixed values to one or more of the coordinates of the starting point Ps of the probing straight line.

17. The method of claim 15, wherein the external calibration or testing system is configured to modify the probing straight line by fixing one of its points and rotating the probing straight line by an angle.

18. The method of claim 10, wherein the up to six torque independent variables include engine torque and up to five motor torques.
